(19) United States
(12) Patent Application Publication
(10) Pub. No.: US 2007/0237278 A1
(43) Pub. Date: Oct. 11, 2007

(54) Inertial fusion reactor device

(76) Inventor: John S. Lamont, Winnipeg (CA)

Correspondence Address: Ryan W. Dupuis;Ade & Company, 1700-360 Main Street, Winnipeg, R3C 3Z3, CA

(21) Appl. No.: 11/217,605

(22) Filed: Sep. 2, 2005

(30) Foreign Application Priority Data
Apr. 12, 2005 (CA) 2,505,105

(51) Int. Cl. H05H 1/22

(52) U.S. Cl. 376/100

(57) ABSTRACT

An inertial fusion reactor device comprises an outer containment chamber and an inner containment chamber supported within the outer containment chamber to define a space between respective walls of the inner and outer containment chambers. Water is contained within the space for generating steam which feeds turbine generators. Fuel for a fusion reaction is suspended within the centre of the inner containment chamber by a suitable mechanism. The reaction is initiated by focussing a plurality of laser beams on the fuel. The structure permits the water to be used both for producing usable steam and for absorbing blast impact due to its incompressible nature.

### FIELD OF THE INVENTION

The present invention relates to an inertial fusion reactor device and more particularly relates to a containment system for capturing energy from an inertial fusion reaction.

### BACKGROUND

Two diverse technical approaches to fusion power are generally known, magnetic confinement fusion, also known as magnetic fusion energy (MFE) and inertial confinement fusion, also known as inertial fusion energy (IFE). These form the basis of a large number of fusion research programs. Magnetic confinement techniques, studied since the 1950s, are based on the principle that charged particles such as electrons and ions, ie, deuterons and tritons, tend to be bound to magnetic lines of force. Thus the essence of the magnetic confinement approach is to trap a hot plasma in a suitably chosen magnetic field configuration for a long enough time to achieve a net energy release, which typically requires an energy confinement time of about one second. In the alternative IFE approach, fusion conditions are achieved by heating and compressing small amounts of fuel ions, contained in capsules, to the ignition condition by means of tightly focused energetic beams of charged particles or photons. In this case the confinement time can be much shorter, typically less than a millionth of a second.

Because the maximum plasma density that can be confined is determined by the field strength of available magnets, MFE plasmas at reactor conditions are very diffuse. Typical plasma densities are on the order of one hundred-thousandth that of air at STP. The Lawson criterion is met by confining the plasma energy for periods of about one second. A totally different approach to controlled fusion attempts to create a much denser reacting plasma which, therefore, needs to be confined for a correspondingly shorter time. This is the basis of inertial fusion energy (IFE).

In the IFE approach, small capsules or pellets containing fusion fuel are compressed to extremely high densities by intense, focused beams of photons or energetic charged particles. Because of the substantially higher densities involved, the confinement times for IFE can be much shorter. In fact, no external means are required to effect the confinement; the inertia of the fuel mass is sufficient for net energy release to occur before the fuel flies apart. Typical burn times and fuel densities are 10⁻¹⁰ s and 10³¹-10³² ions/m³, respectively. These densities correspond to a few hundred to a few thousand times that of ordinary condensed solids. IFE fusion produces the equivalent of small thermonuclear explosions in the target chamber. An IFE power plant design, therefore, must deal with very different physics and technology issues than an MFE power plant, although some requirements, such as tritium breeding, are common to both. Some of the challenges facing IFE power plants include the highly pulsed nature of the burn, the high rate at which the targets must be made and transported to the beam focus, and the interface between the driver beams and the reactor chamber.

In inertial fusion the fuel is compressed and heated using driver beams. Achieving ignition requires a large amount of energy to be precisely controlled and delivered to the fuel target in a very short time, and the target must be capable of absorbing this energy efficiently. To produce net energy, the IFE system must have gain, ie, more energy output than was used to make, compress, and heat the fuel. Driver efficiency and capsule design and fabrication are therefore important issues for an IFE reactor.

The necessary energy can be delivered to the fuel by a variety of possible drivers. The four types of drivers receiving the most research attention are solid state lasers, KrF lasers, light-ion accelerators, and heavy ion accelerators. The leading driver for target physics experiments worldwide is the solid-state laser, and in particular the Nd:glass laser. The reason is that the irradiances required for IFE are, in the 10¹⁸-10¹⁹ W/m² range. The Nd:glass laser was the first driver which could produce these large power densities on target and it has remained in the forefront because of its high performance, reliable technology, and relative ease of maintenance. Low efficiencies and pulse rates have traditionally eliminated Nd:glass lasers from serious consideration in IFE reactor designs. However, new Nd:glass technology, replacing flash lamp pumping with higher efficiency diode pumping and utilizing crystalline disks and gas cooling, could change this view. Higher driver efficiencies are achievable in KrF lasers and particle beam accelerators. Particle beams have thus far had difficulty in achieving the low divergences and small focal spots required for IFE experiments, a technical area where lasers have a natural advantage. In IFE reactors, however, focal spots as large as 1 cm are permitted, and it appears that both light and heavy ion drivers could meet this requirement.

Two types of IFE targets have been investigated known as direct and indirect drive targets. Direct-drive targets absorb the energy of the driver directly into the fuel capsule, whereas indirect-drive targets use a cavity, called a hohlraum, to convert the driver energy to x-rays which are then absorbed by the fuel capsule. This latter method can tolerate greater inhomogeneities in driver illumination, albeit at the expense of the efficient delivery of energy to the capsule.

The extremely high peak power densities available in particle beams and lasers can heat the small amounts of matter in the fuel capsules to the temperatures required for fusion. In order to attain such temperatures, however, the mass of the fuel capsules must be kept quite low. As a result, the capsules are quite small. Typical dimensions are less than 1 mm. Fuel capsules in reactors could be larger (up to 1 cm) because of the increased driver energies available. (Reference: Ellis, William R., 1993, “Fusion Energy” in Encyclopaedia of Chemical Technology, Volume 12, John Wiley & Sons, Inc.)

U.S. Pat. No. 4,690,793 to Hitachi Ltd. et al, U.S. Pat. No. 4,836,972 to Bussard et al, U.S. Pat. No. 5,410,574 to Masumoto et al. and U.S. Pat. No. 6,654,433 to Boscoli disclose various examples of fusion reactions however none describe a simple means of absorbing the force and heat from a fusion reaction to produce useful steam for driving a turbine.

### SUMMARY OF THE INVENTION

According to one aspect of the invention there is provided an inertial fusion reactor device comprising:

an outer containment chamber;

an inner containment chamber supported within the outer containment chamber to define a space between respective walls of the inner and outer containment chambers;

a feed for selectively introducing a liquid into the space between the walls;

a collector for collecting gas generated within the space between the walls;

a target placer for placing a target fuel within the inner containment chamber; and

a driver for compressing and heating the target fuel to initiate a fusion reaction.

By providing a structure in which fluid, for example water, is received within a space between inner and outer chamber walls, the fluid acts both to absorb blast impact due to its incompressible nature, while also producing gas for driving turbine when absorbing heat from the fusion reaction.

There may be provided a shock absorption system coupled in communication with an interior of the inner containment chamber.

The shock absorption system may comprise a moveable column of fluid which is raised when pressure within the inner containment chamber elevates.

There may be provided a valve in communication with the column of fluid for selectively preventing movement of fluid within the column.

There may be provided an inlet chamber defining a volume external from the interior volume of the inner chamber in communication between the interior of the inner containment chamber and the column of fluid.

Preferably both the inner and outer containment chambers are spherical and concentric with one another.

The exterior of the outer containment chamber is preferably heat insulated.

Preferably an interior surface of the inner containment chamber includes a liner of wear resistant material and is formed of a plurality of plates abutted with one another in an overlapping configuration. Each plate may be supported by a respective post spanning the space between the inner and outer containment chambers.

There may be provided a plurality of channels spanning between the inner and outer chambers for receiving driver beams of the driver therethrough. Each channel of the driver preferably includes a cover member for selectively enclosing the channel.

There may be provided a vacuum generator in communication with the interior of the inner containment chamber.

The vacuum generator preferably comprises a fluid port for selectively adding and removing fluid from the interior of the inner containment chamber.

There may be provided a target placer comprising a mechanism for suspending the target fuel at the center of the inner containment chamber.

One embodiment of the invention will now be described in conjunction with the accompanying drawings in which:

### BRIEF DESCRIPTION OF THE DRAWINGS

FIG. 1 is a partly sectional side elevational view of the fusion reactor device.

FIG. 2 is a schematic top plan view of the device.

FIG. 3, FIG. 4 and FIG. 5 are respective top plan, rear elevational and front elevational views of one of the plates forming the walls of the inner containment chamber of the reactor device.

FIG. 6 and FIG. 7 are partly sectional elevational views of a cover member for the driver in open and closed positions respectively.

FIG. 8 is a front elevational view of the cover.

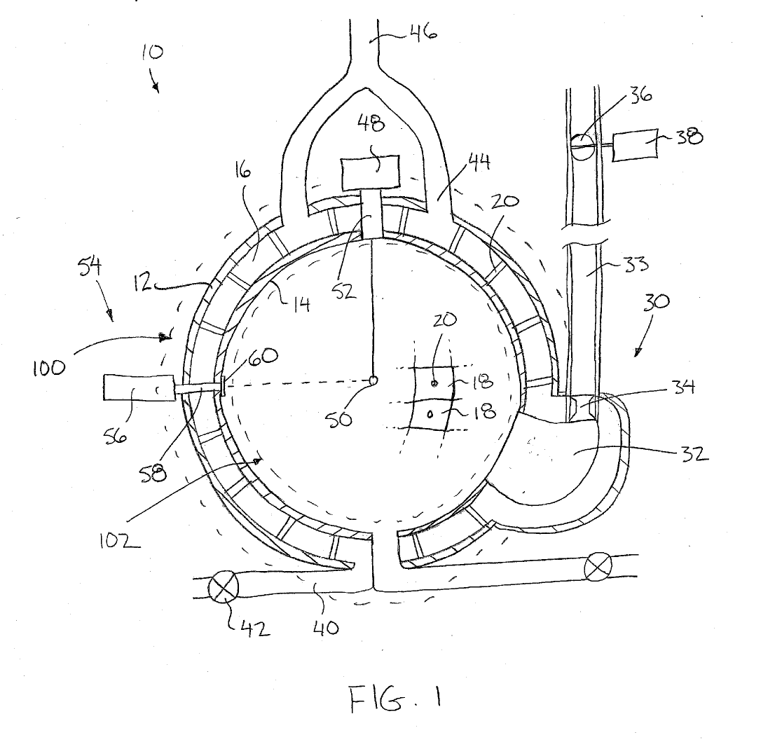

In the drawings like characters of reference indicate corresponding parts in the different figures.

### DETAILED DESCRIPTION

Referring to the accompanying figures there is illustrated a fusion reactor device generally indicated by reference numeral 10. The device 10 is particularly suited for producing useful work from an inertial fusion reaction by capturing steam released when a surrounding fluid is heated.

The device 10 has an outer containment chamber 12 having spherical walls defining a spherical interior. The walls of the chamber are formed of a material having a high heat resistance so as to resist damage from the high heat generated by the reaction. Suitable materials for forming the walls may include various types of metal, ceramic or composite materials which also have sufficient strength to withstand the forces generated by the reaction. The walls are also insulated on an outer side to contain heat in the chamber. A rigid backing, for example concrete, is provided at the exterior of the outer chamber 12 for added structural support. In a typical installation, the device is constructed below ground.

An inner containment chamber 14 also has walls which are spherical in shape and which are positioned concentrically within the outer chamber 12. The inner chamber 14 is smaller in diameter than the outer chamber 12 to define an annular space 16 between the chamber walls of the inner and outer containment chambers. The inner chamber walls are also formed of a material having a high heat resistance and sufficient strength to withstand the heat and force generated by the reaction.

The inner chamber 14 is formed of a plurality of overlapping plates 18 each supported on the outer chamber 12 by a respective post 20 spanning across the space 16 between the walls of the inner and outer chambers. Each plate 18 includes a center post mount on a rear face thereof for connection to the post 20 which mounts on the outer chamber 12. Mounting of the plate to the post 20 is accomplished using threaded fasteners to permit selective separation thereof when the plates become worn and require replacement. The overlapping plates permit some relative movement therebetween to accommodate some expansion of the inner chamber without distortion of the inner chamber walls.

Each plate has a generally rectangular front face 22 which is concave and forms a portion of the inner surface of the inner chamber 14. A top flange 24 extends along the top edge of the front face 22 and a side flange 26 spans one side of the front face 22. Each of the flanges is recessed from the front face 22 by a thickness of the plate for being overlapped by adjacent plates when the front faces 22 thereof are positioned adjacent one another. The top flange 24 is shorter than the overall plate by the width of the side flange 26 so that the flanges do not overlap one another when the front faces of adjacent plates are abutted with one another. Similarly, the side flange 26 is shorter than the plate by the height of the top flange 24. The plates are provided with a close tolerance so that simply abutting the plates in the overlapped configuration described herein is sufficient for providing a seal between the plates for containing water within the annular space 16 between the inner and outer chamber walls.

A shock absorption system is provided in communication with the interior of the inner chamber 14 for reducing the blast impact on the plates 18. The system 30 comprises a plurality of inlet chambers 32 in open communication with the interior of the inner chamber 14 at circumferentially spaced positions about a lower portion of the inner chamber 14. The inlet chambers 32 are much larger than the space between the inner and outer chambers and accordingly each defines a volume which projects externally beyond the inner and outer chamber with the outer chamber being sealed thereabout.

A fluid conduit 34 is coupled to the inlet chamber 32 and extends upwardly therefrom for containing a column of fluid above the inlet chamber. A plug 34 is slidably mounted within the fluid conduit 33 and acts as a seal for containing liquid above the plug and preventing leakage into the inlet chambers. The plug 34 urges the fluid in the conduit upward when pressure in the inlet chambers causes the plugs to rise. At its lowermost position, each plug 34 is substantially flush with or below the communication of the inlet chamber 32 with the interior of the inner chamber 14. A choke valve 36 is coupled to the fluid conduit 34 at a position spaced above the inlet chamber. The choke valve 36 comprises a flap valve which is rotated by a respective actuator 38 between open and closed positions. When closed the choke valve 36 seals the conduit spaced above the plug 34 to prevent further pressure relief of the plug moving upwardly to instead build gas pressure within the interior of the inner chamber 14 and the inlet chambers 32.

In use, the space 16 between the walls of the inner and outer chambers is filled with water received through a feed inlet 40 coupled through the outer chamber walls adjacent the bottom end of the device 10. A feed valve 42 is coupled in series with the feed inlet 40 to seal off the supply of fluid into the space 16 and prevent the back pressure from escaping through the bottom of the device.

A collector in the form of a plurality of steam outlets 44 are coupled through the outer chamber walls in communication with the space 16 at circumferentially spaced positions about the top end of the device. The steam outlets 44 are joined with one another at a common outlet 46 spaced above the inner and outer chambers for collecting any steam produced by the heating of the fluid within the space 16. The common outlet 46 feeds to an electrical generating steam driven turbine.

A target placer in the form of a fuel feeding mechanism 48 is coupled above the inner and outer chambers for depositing target fuel pellets 50 within the interior of the inner chamber 14. The feed mechanism communicates through the walls of the inner and outer chambers by a feed tube 52 extending therethrough. The mechanism 48 selectively feeds pellets 50 into the sphere by suspending the pellet at the center of the sphere prior to the fusion reaction being initiated. The feed tube is sealed closed prior to the reaction being initiated.

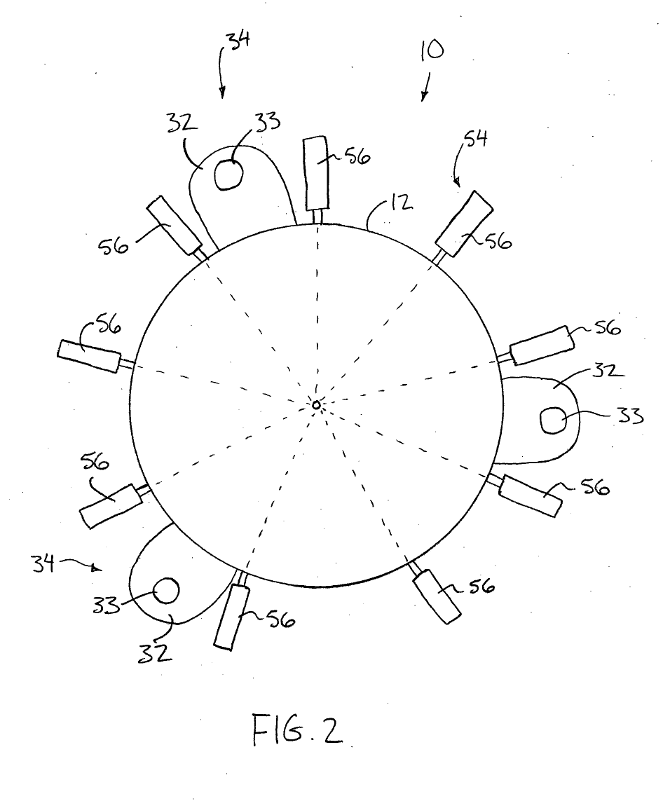

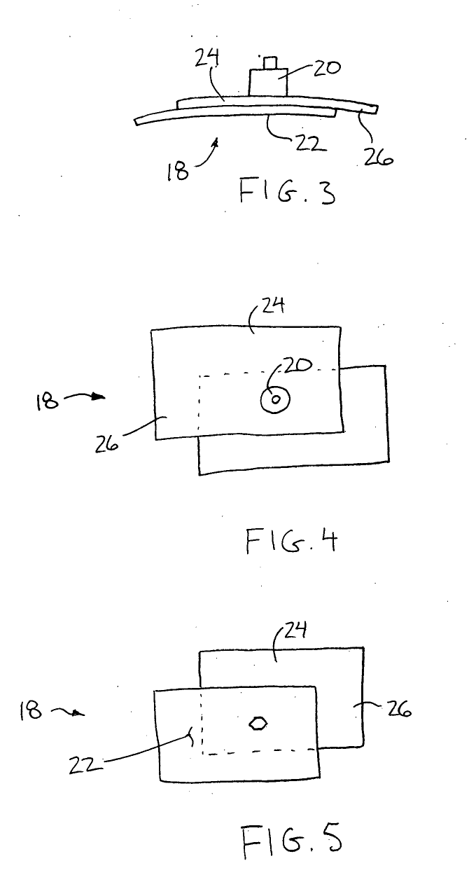

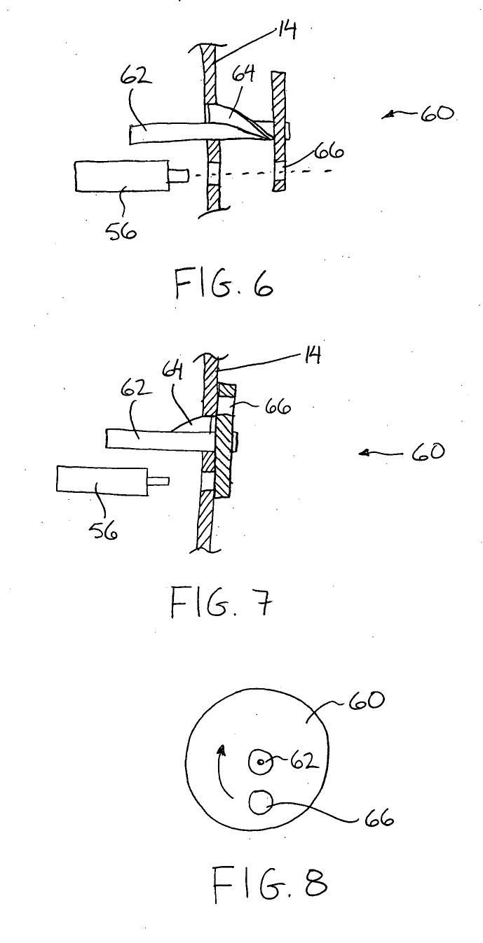

A driver mechanism 54 is provided for initiating the reaction. The mechanism includes a plurality of lasers 56 located at circumferentially spaced positions in one or more drive planes. As shown schematically in FIG. 2 a set of nine lasers are shown in a single driver plane in which each laser is directed at a space between two opposing lasers so that none of the lasers within a single driver plane are directed at one another yet each is directed to cross a single center point within the interior of the inner chamber 14 where the target fuel pellet is suspended. Eight lasers can be provided within a single plane without being directed at one another by positioning the lasers at 40 degrees, 80 degrees, 120 degrees, 160 degrees, 200 degrees, 240 degrees, 280 degrees, 320 degrees and 360 degrees respectively. Each of the lasers communicates through the walls of the inner and outer chambers by a respective driver tube 58 sealed across the space 16 between the chamber walls. Additional lasers may be provided in different planes, but still intersecting the centre of the sphere.

Covers 60 are provided for the driver tubes 58 at the interior of the inner chambers 14 to prevent damage to the driver mechanism during the fusion reaction. Each cover 60 comprises a circular plate supported on a respective axle 62 which is parallel and spaced beside the respective tube 58 in sufficient proximity that the cover plate 60 overlaps the opening of the tube 58. The axle 62 includes suitable flighting 64 thereabout which is engaged within a guide in the inner chamber wall such that the plate is automatically rotated about its axle 62 as the plate is displaced towards and away from the wall of the inner chamber. An aperture 66 is provided in the plate forming the cover 60 for alignment with the respective driver tube 58 when the plate is spaced inwardly from the wall of the inner chamber. When the plate is displaced towards the chamber wall, the flighting 64 causes the plate to rotate until the aperture 66 is no longer aligned with the feed tube when the plate is abutted against the wall of the inner chamber. The feed tube is thus protected when the cover 60 is in this closed position. A suitable biasing mechanism is provided to bias the covers 60 into the respective closed positions.

In use, the plugs 34 are initially positioned at the bottoms of the respective fluid conduits. The space 16 is filled with water and the feed inlet 40 is sealed shut. The interior of the chamber 14 is prepared by first filling the chamber with water and then subsequently draining the water. while partially filing the remaining volume with an inert gas so that. once all of the water is drained from the inner chamber a partial vacuum of only inert gas is all that remains within the inner chamber 14. A target fuel pellet 50 is then suspended within the interior of the inner chamber at the center thereof and the feed tube is sealed shut prior to the driver mechanism being activated to initiate the reaction. Once the lasers 56 are activated, the driver tubes are immediately closed as the fusion reaction begins. The build up of heat and pressure within the interior of the inner chamber 14 exerts pressure on the plugs 34 through the inlet chamber 32 to raise the fluid in the conduit 33 thereabove and thereby absorb some of the initial blast pressure of the fusion reaction. Once the initial blast is absorbed, the choke valves 36 are closed to contain as much heat and pressure within the inner chamber as possible. Subsequently opening the choke valves 36 again causes the fluid in the conduits 33 to urge the plugs 34 back down to the starting position to maintain pressure during the cooling phase of the interior of the inner chamber 14. Cooling of the interior of the inner chamber occurs by transferring heat to the water in the space 16 which produces steam to drive a turbine as noted above.

Typically, plural devices 10 would be operated and commonly feed their steam together to suitable turbine equipment. The reaction sequence of the devices would be arranged so that the resulting blasts would be evenly spaced at regular intervals so as to produce as constant a pressure of steam as possible. Accordingly, the reaction within each device takes place while adjacent devices are at different stages of preparation for another reaction.

As described above, scientific research has demonstrated that certain types of lasers and particle beams are capable of producing the necessary temperatures to induce fusion from small capsules of isotopes of hydrogen, such as deuterium and tritium, when targeted by beams from a number of directions, typically as many as eight. The original beam might be mirrored to produce beams in these directions, and would probably require amplification by accelerators.

As further described herein, the fusion reactor device generally comprises of a circular sphere consisting of an inner and outer shell with an appropriate space between them, and appropriately spaced structural plugs separating the shells. The inner shell is coated with an appropriate liner material, such as silicon carbide, and could consist of layered sheets. The outer shell might require to be reinforced with a layer of concrete, and would require an outer blanket of insulation to impede the escape, of heat.

The inner shell is fastened to the outer shell and concrete with long bolts through appropriate channels to enable the inner shell to be removed and replaced. The whole sphere has channels for the driver beams.

The space between the two shells is filled with water to absorb the heat produced the fusion and let off to a suitable chamber as steam, from which it is utilized to drive a steam turbine. A flow of water into the space is maintained until there is no longer sufficient heat to create steam. Since water is not compressible, the water would serve to strengthen the shell at the time of the initial fusion impulse.

The sphere has mechanisms to absorb and cushion the initial pressure in the form of appropriately sized water channels located just above openings in the bottom half of the sphere and leading upward to an appropriate water source such as a lake or river. The length of the channels makes it ideal for the sphere to be located underground. The channels would be plugged at the bottom, but with a plug capable of lifting the water channel when required to absorb the pressure produced by the fusion. The channels could be combined into one at an appropriate height. The pressure is confined at some point by choking off the upward flow and allowing the plugs to maintain pressure by sinking under the pressure of the water above back to its original position as pressure in the sphere reduces.

A further channel provides water to the space between the two shells from the bottom of the sphere, with a suitable valve to prevent back pressure from the steam, and with sufficient pressure to provide a flow of water to replace the water converted into steam.

The fuel capsule is presented by dropping it from the top of the sphere by an appropriate mechanism through a hole which could be immediately closed. The fuel feeding mechanism suspends the capsule in the middle of the sphere where the beams intercept one another to initiate the reaction on contact of the beams with the fuel. Mechanisms close the beam channels immediately after the beams were sent to the fuel capsule to prevent the escape of pressure through those channels. Circular rotating disks with one or more holes to uncover the channels serve this purpose. The disks would have a central axle, with a raised curved disk operating within a clasp to rotate when pushed to open, with spring loading to retract the disk when it is desired to close the channels.

It may be desirable to create a partial vacuum within the sphere prior to firing. This could be created by filling the inner sphere with water and then drawing it off from the bottom. To the extent that some gaseous material was desirable within the sphere during firing, this could be provided by an inert gas, preferably helium, which can be introduced during the draining process.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. In an inertial fusion reactor device comprising:
an outer containment chamber;
an inner containment chamber supported within the outer containment chamber to define a space between respective walls of the inner and outer containment chambers;
a liquid filling the space between the walls of the inner and outer containment chambers;
a target placer arranged to place a target fuel within the inner containment chamber;
a driver arranged to compress and heat the target fuel to initiate a fusion reaction;
the improvement comprising:
a feed arranged to introduce the liquid into the space between the walls and to maintain liquid in the space;
the liquid within the space between the walls of the inner and outer containment chambers being arranged to form a gas in the space between the walls of the inner containment chamber and the outer containment chamber responsive to the fusion reaction; and
a collector arranged to collect the gas formed in the space directly from the space between the respective walls of the inner and outer containment chambers as the liquid in the space is heated by the fusion reaction.

2. The device according to claim 1 wherein there is provided a shock absorption system coupled in communication with an interior of the inner containment chamber.

3. The device according to claim 2 wherein the shock absorption system comprises a moveable column of fluid which is arranged to be lifted when pressure within the inner containment chamber elevates.

4. The device according to claim 3 wherein there is provided a valve in communication with the column of fluid, the valve being operable between an position and a closed position in which the valve prevents further movement of fluid within the column in the closed position such that further relief of pressure in the inner containment chamber is prevented when the valve is closed.

5. The device according to claim 3 wherein there is provided an inlet chamber defining a volume external from an interior volume defined by the inner chamber and in communication between the interior of the inner containment chamber and the column of fluid.

6. The device according to claim 1 wherein both the inner and outer containment chambers are spherical and wherein the chambers are concentric with one another.

7. The device according to claim 1 wherein an exterior of the outer containment chamber is insulated.

8. The device according to claim 1 wherein an interior surface of the inner containment chamber includes a liner of wear resistant material.

9. The device according to claim 1 wherein the inner containment chamber is formed of a plurality of plates abutted with one another in an overlapping configuration.

10. The device according to claim 9 wherein each plate is supported by a respective post spanning the space between the inner and outer containment chambers.

11. The device according to claim 1 wherein there is provided a plurality of channels spanning between the inner and outer chambers arranged to receive respective driver beams of the driver therethrough.

12. The device according to claim 11 wherein each channel includes a cover member, the cover member being operable between a first position.

13. (canceled)

14. (canceled)

15. The device according to claim 1 wherein the target placer comprise s a mechanism arranged to suspend the target fuel at a center of the inner containment chamber.

16. In an inertial fusion reactor device comprising:
an outer containment chamber;
an inner containment chamber supported within the outer containment chamber to define a space between respective walls of the inner and outer containment chambers;
a liquid filling the space between the walls of the inner and outer containment chambers;
a target placer arranged to place a target fuel within the inner containment chamber;
a driver arranged to compress and heat the target fuel to initiate a fusion reaction;
the improvement comprising:
a feed arranged to introduce the liquid into the space between the walls and to maintain liquid in the space;
the liquid within the space between the walls of the inner and outer containment chambers being arranged to form a gas in the space between the walls of the inner containment chamber and the outer containment chamber responsive to the fusion reaction;
a collector arranged to collect the gas formed in the space directly from the space between the respective walls of the inner and outer containment chambers as the liquid in the space is heated by the fusion reaction;
a shock absorption system coupled in communication with an interior of the inner containment chamber, the shock absorption system comprising;
a moveable column of fluid which is arranged to be lifted under force of elevating pressure within the inner containment chamber to relieve pressure in the inner containment chamber; and
a valve in communication with the column of fluid, the valve being operable between an open position and a closed position in which the valve prevents movement of fluid within the column in the closed position such that relief of pressure in the inner containment chamber is prevented when the valve is closed.

17. (canceled)

18. The device according to claim 16 wherein there is provided an inlet chamber defining a volume external from an interior volume defined by the inner chamber and in communication between the interior of the inner containment chamber and the column of fluid.

19. In an inertial fusion reactor device comprising:
an outer containment chamber;
an inner containment chamber supported within the outer containment chamber to define a space between respective walls of the inner and outer containment chambers;
a liquid filling the space between the walls of the inner and outer containment chambers;
a target placer arranged to place a target fuel within the inner containment chamber;
a driver arranged to compress and heat the target fuel to initiate a fusion reaction;
the improvement comprising:
a feed arranged to introduce the liquid into the space between the walls and to maintain liquid in the space;
the liquid within the space between the walls of the inner and outer containment chambers being arranged to form a gas in the space between the walls of the inner containment chamber and the outer containment chamber responsive to the fusion reaction;
a collector arranged to collect the gas formed in the space directly from the space between the respective walls of the inner and outer containment chambers as the liquid in the space is heated by the fusion reaction;
the walls of the inner containment chamber being formed of a plurality of plates abutted with one another in an overlapping configuration; and
each plate being respectively supported on the walls of the outer containment chamber by a respective post spanning the liquid filled space between walls of the inner and outer containment chambers.

20. (canceled)
